(19) United States
(12) Patent Application Publication
(10) Pub. No.: US 2025/0341148 A1
(43) Pub. Date: Nov. 6, 2025

(54) REDUCING METHANE AND METHANE PRODUCTION IN ORGANIC WASTE WELLS

(71) Applicant: Advantek Waste Management Services, LLC, Houston, TX (US)

(72) Inventors: Omar Abou-Sayed, Houston, TX (US); Ibrahim Mohamed, Houston, TX (US)

(21) Appl. No.: 18/866,517

(22) PCT Filed: Jul. 24, 2023
(86) PCT No.: PCT/US2023/070830

§ 371 Date: Nov. 15, 2024

Related U.S. Application Data
(60) Provisional application No. 63/369,236, filed on Jul. 24, 2022.

(51) Int. Cl. E21B 41/00; B01D 53/72; B01D 53/84; C01B 3/40; C09K 8/60

(52) U.S. Cl. CPC E21B 41/005; B01D 53/72; B01D 53/84; C01B 3/40; C09K 8/605; B01D 2257/7025; C01B 2203/0233; C01B 2203/1058

(57) ABSTRACT

Methods for reducing methane or methane production from organic material decomposition in a subterranean formation, or from formations leaking methane, include injecting reactants, biocides, or methanotrophic bacteria into the formation.

### CROSS-REFERENCE TO RELATED APPLICATIONS

This is an International Application for Patent under the auspices of the PCT and claims priority to prior-filed U.S. Provisional Application No. 63/369,236, filed Jul. 24, 2022.

### FIELD

The disclosed methods and apparatus generally relate to reducing the occurrence and severity of potential methane gas leaks from subterranean storage sites, and more particularly to arresting or retarding methane production after injecting biosolids into a subterranean formation, cavern or cavity.

### BRIEF DESCRIPTION OF THE DRAWING

Drawings of the preferred embodiments of the present disclosure are attached hereto so that the embodiments of the present disclosure may be better and more fully understood:

FIG. 1 is a schematic of an exemplary injection well disposal operation according to embodiments of the disclosure herein.

### DETAILED DESCRIPTION OF CERTAIN EMBODIMENTS

It would be advantageous to arrest or immobilize methane production downhole after injecting organic waste, such as biosolids, into a subterranean formation. As used herein, subterranean formation includes subterranean caverns, brine filled cavities, permeable zones, and other underground formations and reservoirs. Although methane is a usable fuel, it may be advantageous to prevent or reduce methane production of materials injected into a subterranean formation for purposes of carbon sequestration, to prevent or reduce the risk of methane leakage from the injection zone to the surface or other zones, or to meet requirements for receiving carbon credit for the injection or sequestration. The methods described may be used for methane production reduction in injection formations under other circumstances as well, and to reduce the risk of methane leakage from subsurface methane accumulations more generally.

Organic waste can be disposed of, or sequestered, in subterranean formations using injection wells. The organic waste can be traditional waste material, such as sewage sludge or waste water from hydrocarbon production, or carbon bearing materials identified, produced or modified for the purpose of injection to sequester carbon or earn carbon credits. The organic waste is often treated to create an injectable slurry, such as through the addition of fluids, straining or grinding of solids, and the like, as is known in the art. The organic waste is then injected into the subterranean formation using one or more injection wells using known techniques.

When injecting organic waste geologically, there can be methane production through anaerobic decomposition. Carbon dioxide (CO2) in the organic waste may dissolve into formation brine at reservoir conditions, while methane produced from the organic waste can, in a reservoir, be immobilized within the pore space where generated until there is sufficient aggregated methane to overcome the residual gas saturation. In a cavern or other open space, the methane will migrate to the top of the formation. An appropriate well management design and monitoring precautions should successfully prevent any methane (or other gas) leakage from the formation or well. However, accidents, improper design and maintenance, failed monitoring, and external events, like earthquakes and the like, may result in a loss of seal in the injection zone or other leak path for the methane to release back into the atmosphere or into adjacent formation zones.

Additionally, there are a large number of abandoned hydrocarbon wells which leak methane gas due to failed or inadequate plugging of the well upon abandonment. In some cases, natural methane leaks occur from underground sources. Remediation of these methane leak sources is desirable to reduce methane release into the atmosphere.

Methane in the atmosphere is highly undesirable. Methane is a major contributor to the formation of ground-level ozone, an air pollutant and greenhouse gas. Methane itself is also a greenhouse gas. It is estimated that methane, over a 20-year period, is 80 times more potent at warming the earth than carbon dioxide. Consequently, if a leak of methane from disposed or sequestered organic waste occurs, the result may be worse for the environment than if the organic waste had been left to decompose naturally into CO2 at surface.

### Disposal Wells

Generally, disposal or sequestration wells are used to inject organic waste materials into a subterranean formation as a means of convenient disposal of materials not wanted above ground, or as a means of sequestering carbon bearing materials for environmental purposes.

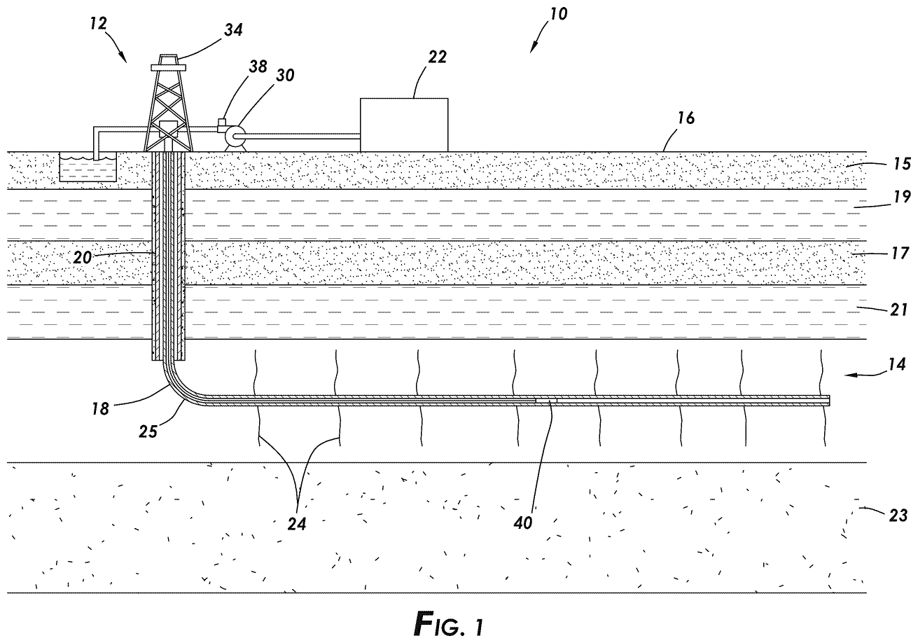

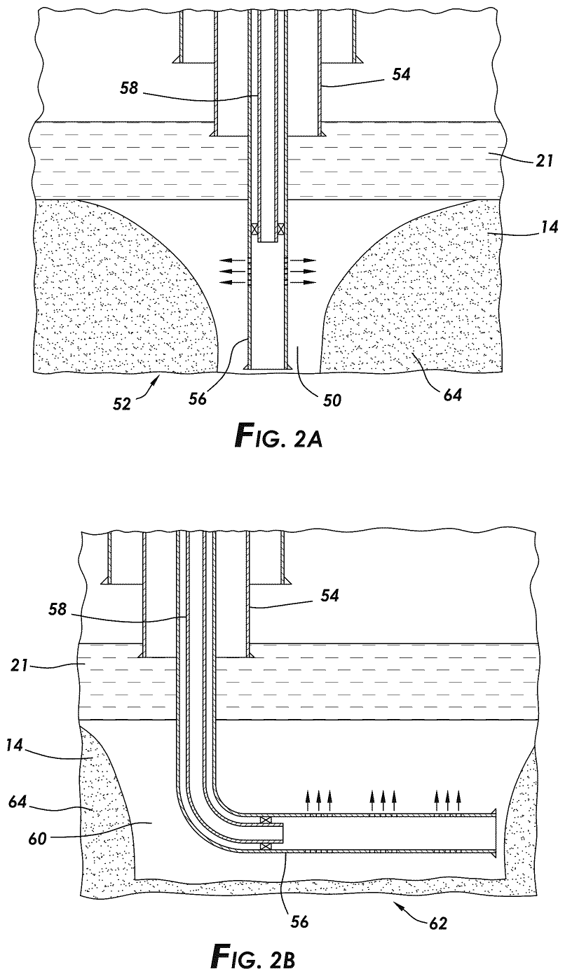

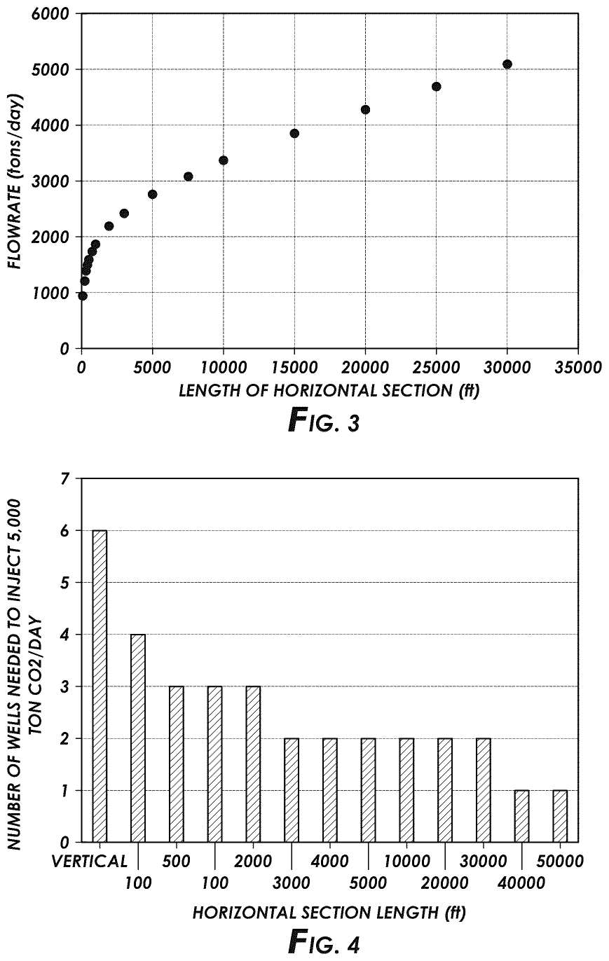

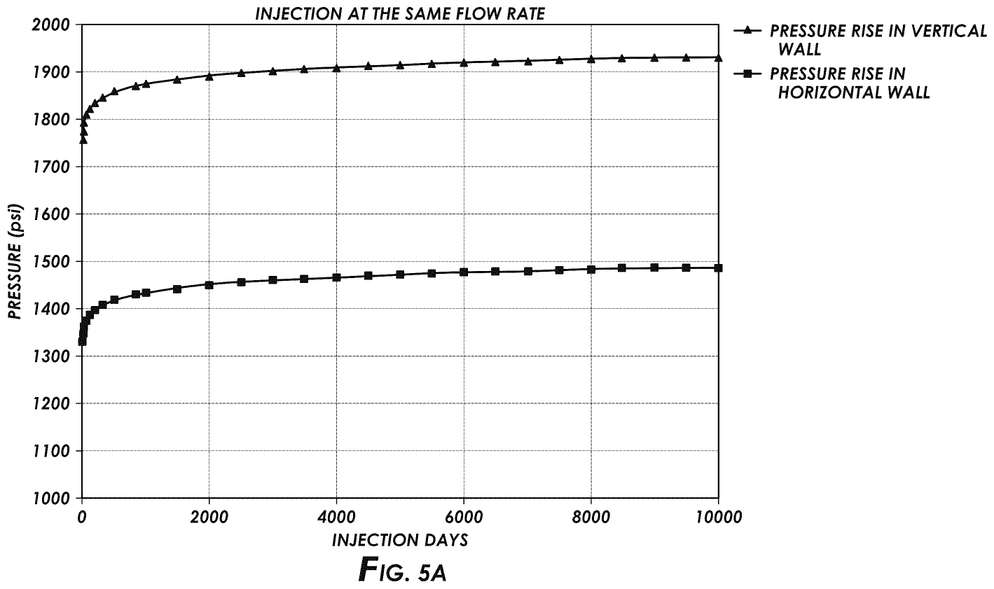

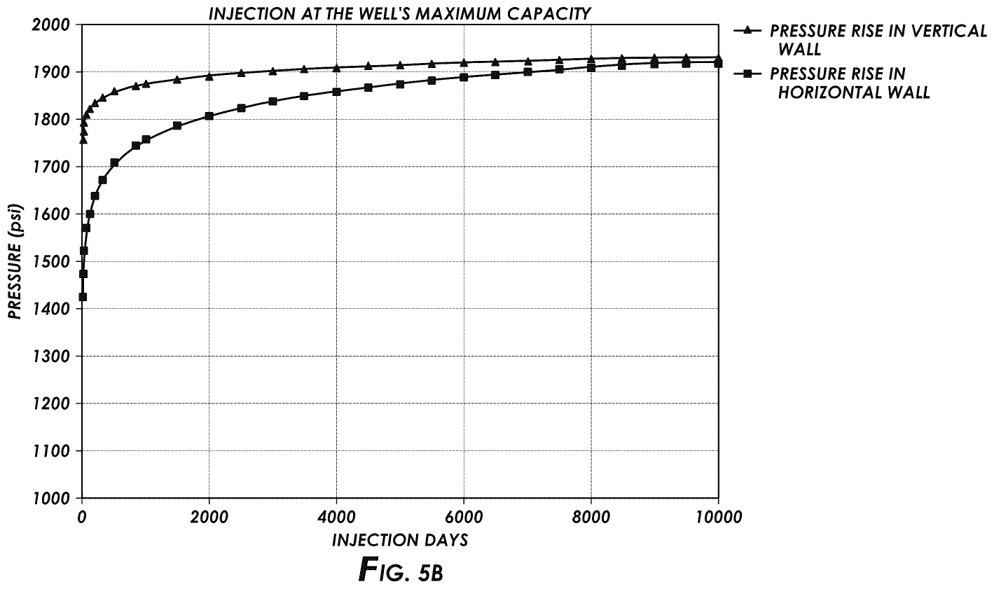

FIG. 1 is a schematic of an exemplary onshore oil or gas drilling rig and wellbore, in cross-section, according to an aspect of the invention, the system generally designated 10. Rig 12 is positioned over a subterranean formation, below the earth's surface 16, having multiple layers or strata of zones with varying properties. The target zone 14 is a formation targeted for injection of organic materials disposal or sequestration and has corresponding properties allowing the injection, movement, and storage of fluids. The containment zone 21, above the target zone 14, conversely has properties preventing the flow of fluids and is useful for containing fluids and gases, such as methane, which may be present in the target zone 14 from migrating upwards into or past the containment zone 21. Additional zones 15, 17 and 19, can have various properties. For example, in many locations a drinking water zone 19 may be present having relatively fresh water, not briny, used for human consumption.

The surface facility 12 is exemplary to generally indicate surface equipment necessary for performing pumping at pressure into the target formation for injecting fluids, along with surface equipment for storing, preparing and maintaining various pre-injectate and injectate fluids. Such equipment can be used for various operations, such as injection, wellbore flushing, disposal or storage, etc. The surface facility 12 can include injection pumps, coiled tubing equipment, wireline equipment, and the like, as is known in the art. Similarly, coiled tubing and wireline operations can be run in the well. Pump 30 is capable of pumping a variety of wellbore compositions of various consistencies into the well. One or more pressure measurement devices 38 provide pressure readings, for example, at the pump discharge, wellhead, primary and annular bores, etc.

Wellbore 18 has been drilled through the various earth strata, including formation zone 14. Upon completion of drilling, casing 20 is typically cemented in place in the wellbore 18 to facilitate the production of oil and gas from the targeted formation and or to re-establish the integrity of the containment zone which is otherwise compromised when penetrated by the wellbore 14 while isolating non-targeted formations such as, for example, aquifer formations 15 and 17, and aquiclude or impermeable layers 19 and 21. The targeted formation zone 14 is bounded above and below by containment layers 21 and 23. The targeted zone 14 is can be a saline aquifer or other reservoir zone with the properties necessary to inject, allow subterranean movement of, and store large volumes of injected material. It is understood that the aquifer can have additional fluid components.

The wellbore extends from the surface to the target formation. It is understood that the wellbore can be vertical, horizontal, or other known orientations as are used in the art. The exemplary well shown has a horizontal section. Casing 20 extends downhole along wellbore 18 through selected section of the wellbore. As shown, the casing 20 extends along the vertical section of the wellbore, although casing can also be positioned along the horizontal section if desired. The casing annulus between the casing 20 and wellbore wall 18 contains cement to secure the casing 20 in place and prevent leakage upwards on the outside of the casing. If casing is used along the target zone, the casing can be pre-perforated or perforated in place using typical perforation techniques. More often, a liner 25 is positioned in the wellbore, extending or hung from the casing. The liner 25, at the target zone, is pre-perforated, slotted, or perforated at its downhole location. The perforations provide fluid communication between the target zone 14 and the wellbore 18 interior to the casing or liner. Alternately, the wellbore at the target zone can be open hole. A tubing annulus is formed between the casing or liner and any work string positioned therein. An exemplary downhole tool assembly 40 is shown in the wellbore 18 and can be one or more downhole tools, connected or disconnected, on a wireline, workstring, or other conveyance, or permanently installed in the wellbore. For example, the tool assembly 40 can include an array of sensors for data acquisition and transmission.

In some embodiments, the methods are used with respect to a target zone which has been previously hydraulically fractured, creating exemplary cracks 24. The fractures can intersect one another, creating a connected fracture network. In some cases, multiple sections of the target zone are injected, sometimes sequentially, and can be fluidly isolated from one another to allow, in conjunction with isolation or barrier devices, downhole valves, and the like, control of fluid communication with each section of the zone.

While the illustration depicts a subterranean formation having a permeable and porous zone, those of skill in the art will understand that the disclosure herein can be used as well in subterranean caverns, brine filled cavities and the like.

During preparation for downhole injection, an injectate, pre-injectate, or other injection materials can be stored and/or treated in a surface tank or facility 22 or the like. In ground tanks may be employed as well. Once the injectate is prepared, it is pumped downhole by a pump 30 under pressure. Waste fluids 40 are injected into the target zone during disposal operations. Typically waste fluids 40 are prepared prior to disposal into a slurry, for waste slurry injection. Terms such as “waste fluids,” “waste slurry,” and the like are used interchangeably herein without limitation. Preparation can include sifting and screening, separation, grinding of particles, rheological treatment, addition of selected bacteria and organisms, dilution, dewatering and the like. The term organic waste bearing materials is used herein to refer to organic waste whether it is mixed with additional materials or fluids, such as water, brine or the like, or contains additives and other chemicals.

Pumping equipment, such as an injection pump 30 is positioned connected to the wellhead to pump organic waste bearing fluids into the wellbore under pressure. In some cases, the pumping is performed at pressures high enough to create new or additional fractures in the subterranean formation.

Methane Production from Organic Waste Disposal and Other Wells

Organic waste contains a relatively high carbon content and is often slated for disposal, with or without remedial efforts to reduce the carbon content of the organic material which might otherwise be released into the environment. For example, some organic waste material, such as sewage and the like, is typically treated in multiple stages. Sewage may be treated with aerobic, anaerobic and facultative bacteria which consumes complex carbon bearing materials (i.e., long chain carbon chemicals) and releases as a byproduct methane and carbon dioxide. The methane may be vented, flared, or used as a fuel, for example in sewage treatment equipment. Similarly, other organic wastes can be slurrified or prepared for disposal, such as waste organic materials such as food, contaminated fluids and solids, contaminated soil and the like. The sources and content of organic waste material is understood by those of skill in the art and is not listed exhaustively herein.

The resulting waste slurry or portions thereof can be injected into a subterranean formation to dispose of the carbon rich waste. However, the bacteria seeded in the waste, whether through an intentional process at a treatment plant or otherwise, is injected as well, resulting in methane production in the subterranean formation. Such methane is subject to potential leakage from the subterranean formation and well.

Another source of methane from subterranean formation is leaking abandoned wells and the like. It is believed that thousands of abandoned wells are leaking methane due to failed sealing systems, improper abandonment plugging procedures, or from external factors. Reduction or elimination of methane production or leakage from these wells is also desirable to reduce methane released into the atmosphere. It is understood that the processes disclosed herein can be applied to methane leaking formations. In some cases the methane is leaked to the surface through a wellbore. In other cases, the methane is leaking to the surface through a crack system extending from the formation to the surface. In some cases, a formation has numerous wells extending therethrough with one or more of the wellbores leaking methane. As used herein, a formation leaking methane is understood to include leaks through a wellbore or through earth strata.

### Reduction of Methane or Methane Production

Consequently, methods are needed to reduce the methane present in subterranean formations and the methane produced in subterranean formation.

### Use of Biocide

An exemplary method of reducing methane or methane production in a subterranean formation is through the application of a biocide to the organic waste bearing material. The biocide can be applied directly or as part of solution or mixture of materials. The biocide can be applied to the organic waste before injection, such as by mixing of the biocide into the pre-injectate at an above ground tank or facility. Further, the biocide can be mixed with the organic waste at the time of injection. That is, the biocide and the organic waste bearing material can be injected together, such as in a single injection batch. The biocide can be injected into the formation after an organic waste bearing injectate is injected. Finally, the biocide can be injected into a wellbore and related subterranean formation which is leaking methane, regardless of whether the well was once a disposal well, organic waste well or the like.

In an exemplary method, organic waste bearing fluid is injected into the subterranean formation through the wellbore, the organic waste bearing fluid including a methane producing bacteria. The organic waste bearing fluid can be treated organic waste as discussed above. Methane is then produced by the bacteria in the subterranean formation. A biocide bearing fluid is then injected into the subterranean formation and at least a portion of the methane producing bacteria in the subterranean formation is eliminated. The injection of biocide can be accomplished through salt flushing, or the injection of a hypersaline water. The biocide bearing fluid can include at least one of the following biocides: chlorine, chlorine dioxide, hydrogen peroxide, bromine, ozone, and ammonium compounds. Other biocides can be employed as will be readily apparent to those of skill in the art.

In an exemplary method, the hypersaline water biocide is waste brine produced at a biowaste treatment plant by reverse osmosis processes. It is common in organic waste treatment facilities to use reverse osmosis to separate materials in a solution. This results in a waste material of brine. The brine can be used as a biocide for the methane generating bacteria, thus eliminating the brine waste and reducing methane production in the subterranean formation.

While a single treatment of a subterranean formation with a biocide may reduce the presence of methane producing bacteria, it may be advantageous to repeatedly flush the well and formation with a biocide.

### Methanotrophic Bacteria

Another process for reducing the methane from a subterranean formation is through converting the methane to a more preferred substance.

In an exemplary method of reducing methane in a subterranean formation, an anaerobic methanotrophic bacteria bearing fluid is injected into the subterranean formation. A portion of the methane is eliminated by the methanotrophic bacteria. The methanotrophic bacteria bearing fluid can be injected alone or with organic waste bearing fluid. The organic waste bearing fluid, regardless of the relative timing of injection, may contain methane producing bacteria which produces methane by consuming the organic waste in the formation.

Injecting a methanotrophic bacteria into the formation can present certain problems. For example, if little or no methane is yet present in the formation, or in the also injected organic waste bearing fluid, then the bacteria will lack for immediate food. Consequently, it may be desirable to also inject methane into the subterranean formation as food for the methanotrophic bacteria. Finding a source for the methane to be injected may be relatively easy, as methane is often produced as a waste gas or byproduct in organic waste treatment plants.

In an alternative or complimentary method, a complex carbon chemical and a reduction agent can be injected into the subterranean formation. Here, the complex carbon chemical is understood to be a carbon bearing material with more carbon per molecule than the relatively simple methane. The complex carbon material provides carbon based chemicals which can be broken down into methane, which then acts as fuel for the methanotrophic bacteria. A reduction agent can also be injected for the purpose of reducing the complex carbon chemical into a simple carbon chemical consumable by the methanotrophic bacteria.

As explained elsewhere, it is understood that the injection sequence of organic waste bearing fluid, methanotrophic bacteria bearing fluid, and, where used, complex carbon chemicals and reduction agents can vary. For example, all of the fluids can be injected into the subterranean formation in a single batch. Here, as elsewhere herein, an injectant fluid can include various carrier fluids, additives, and other substances. As also explained above, the process can be used on methane leaking formations and wells.

### Creation of Complex Carbon Chemicals

Methane is prone to leakage in some respects because it is a gas, has low viscosity, and can migrate relatively easily through a formation and along leak paths. Conversion of methane to a more complex carbon chemical, more viscous and less likely to easily travel can reduce the likelihood of leaks.

Therefore, a method of potentially reducing the amount of methane or methane production in a subterranean formation includes injecting a reactant bearing fluid into the subterranean formation. In the formation, the reactant reacts with the methane to create a more complex carbon bearing chemical, such as a liquid carbon chemical. In some embodiments, a catalyst bearing fluid can also be into the subterranean formation to catalyze the reaction. It is understood that the reactants and catalysts can be carried or mixed with additional fluids and additives to enhance delivery, injection, etc. Further, it is understood that the term “liquid” as used with respect to the chemicals resulting from the subterranean reaction is with reference to the state of the chemical at ambient temperature and pressure. While some of the named chemicals may in fact remain as liquid in the formation, the state of the chemical will depend on the conditions in the formation. Regardless of state in the formation, the more complex carbon chemicals will tend to be less likely to leak as they will tend to remain liquid or condense to liquid prior to escaping as a gas. Further, where reactions result in a gas byproduct, that byproduct is less damaging to the environment than methane.

In one embodiment, chlorine is injected as the reactant, the chlorine reacting with the methane to produce liquid carbon tetrachloride and hydrochloric acid.

In an embodiment, iodine is injected as the reactant, and reacts with the methane to produce liquid methyl iodide and liquid hydrochloric acid.

In an embodiment, an iron bearing chemical is injected as the reactant, and reacts with the methane to produce methanol.

In an embodiment, an aqueous solution is injected as the reactant, and reacts with the methane to produce hydrogen and methanol.

In an embodiment, cerium oxide or copper oxide is injected as the reactant and reacts with the methane to produce methanol.

In an embodiment, steam is injected and a nickel bearing catalyst to create a reaction to produce hydrogen and carbon dioxide.

In an embodiment, at least one catalyst bearing fluid is injected into the subterranean formation.

In an embodiment, halogen is injected as the reactant and reacts with the methane to produce a haloalkane.

In another method, the reactant can be designed to react with chemicals in situ in the subterranean formation. For example, where brine is already present in the formation, the chemical reaction to change methane to a more complex chemical can rely on and use the brine or its constituents as part of the reaction. Typical chemicals present in situ in the formation can include water, brine, limestone and other formation rock, hydrocarbons, hydrogen, etc., as is known in the art.

As with the other methods disclosed herein, an organic waste bearing fluid can be injected into the subterranean formation, the organic waste bearing fluid including a methane producing bacteria. The order of injection may vary, and multiple components can be injected in a single batch. For example, organic waste bearing material can be injected into the formation where it will produce methane. At a later time or times, one or more reactant bearing fluids can be injected to convert the produced methane into a more desirable chemical or chemicals. Further, additional reactants can be injected to further change the byproducts of the initial reaction.

As with the methods explained elsewhere herein, the injection of reactant can be performed on a well or wellbore which is leaking methane from the subterranean formation. As explained elsewhere, it is understood that the injection sequence of organic waste bearing fluid, methanotrophic bacteria bearing fluid, and, where used, complex carbon chemicals and reduction agents can vary. For example, all of the fluids can be injected into the subterranean formation in a single batch. As also explained above, the process can be used on methane leaking formations and wells.

### In Situ Combustion of Methane

In another method of reducing methane presence in a subterranean formation, the methane is combusted in situ in the formation. For example, an organic waste bearing fluid is injected into the formation, where it breaks down into methane. That methane is then combusted in the formation, eliminating some or all of the methane from the formation. The method can also include injecting chemicals to enhance, make possible, prolong or otherwise improve the combustion process. For example, an oxygen bearing gas or fluid can be injected into the subterranean formation, wherein the oxygen mixes with the methane enabling or enhancing the in situ combustion. In situ combustion can be combined with another of the techniques mentioned above which require heat addition, such as the endothermic reaction of methane with steam to produce H2 and CO2 in the presence of a nickel catalyst (steam methane reformation).

### Reduction of Methane Producing Bacteria in Pre-Injectate

In the traditional treatment of organic waste, for example sewage and the like, it is typical to seed the waste with methane producing bacteria. The bacteria is introduced to reduce the bulk of the waste by producing methane which can be isolated from the waste and disposed of or used elsewhere. The bacteria is used aerobically and anaerobically. Some biowaste, such as manure and the like, naturally include such bacteria.

To reduce, slow or eliminate the production of methane, in an embodiment, the organic waste treatment process is modified to eliminate the introduction of methane producing bacteria. The downside of eliminating this step of waste treatment is that the resulting waste for injection has greater bulk. However, that limitation is offset by the reduction of methane production and leakage. In some embodiments, a pre-injectate having methane producing bacteria is treated, prior to injection, to remove the methane producing bacteria. For example, a method can comprise removing the methane generating bacteria from the pre-injectate organic waste material; creating an injectate organic waste bearing fluid including the pre-injectate form which the methane producing bacteria has been removed, and injecting the organic waste bearing fluid into the subterranean formation.

### CONCLUSION

The words or terms used herein have their plain, ordinary meaning in the field of this disclosure, except to the extent explicitly and clearly defined in this disclosure or unless the specific context otherwise requires a different meaning. If there is any conflict in the usages of a word or term in this disclosure and one or more patent(s) or other documents that may be incorporated by reference, the definitions that are consistent with this specification should be adopted.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

While the foregoing written description of the disclosure enables one of ordinary skill to make and use the embodiments discussed, those of ordinary skill will understand and appreciate the existence of variations, combinations, and equivalents of the specific embodiments, methods, and examples herein. The disclosure should therefore not be limited by the above described embodiments, methods, and examples. While this disclosure has been described with reference to illustrative embodiments, this description is not intended to be construed in a limiting sense. Various modifications and combinations of the illustrative embodiments as well as other embodiments of the disclosure will be apparent to persons skilled in the art upon reference to the description. It is, therefore, intended that the appended claims encompass any such modifications or embodiments.

The particular embodiments disclosed above are illustrative only, as the present disclosure may be modified and practiced in different but equivalent manners apparent to those skilled in the art having the benefit of the teachings herein. It is, therefore, evident that the particular illustrative embodiments disclosed above may be altered or modified and all such variations are considered within the scope of the present disclosure. The various elements or steps according to the disclosed elements or steps can be combined advantageously or practiced together in various combinations or sub-combinations of elements or sequences of steps to increase the efficiency and benefits that can be obtained from the disclosure. It will be appreciated that one or more of the above embodiments may be combined with one or more of the other embodiments, unless explicitly stated otherwise. Furthermore, no limitations are intended to the details of construction, composition, design, or steps herein shown, other than as described in the claims.

The systems, methods, and apparatus in the embodiments described above are exemplary. Therefore, many details are neither shown nor described. Even though numerous characteristics of the embodiments of the present disclosure have been set forth in the foregoing description, together with details of the structure and function of the present disclosure, the present disclosure is illustrative, such that changes may be made in the detail, especially in matters of shape, size and arrangement of the components within the principles of the present disclosure to the full extent indicated by the broad general meaning of the terms used in the attached claims. The description and drawings of the specific examples above do not point out what an infringement of this patent would be, but are to provide at least one explanation of how to make and use the present disclosure. The limits of the embodiments of the present disclosure and the bounds of the patent protection are measured by and defined in the following claims.

1. A method of reducing methane production in a subterranean formation having a wellbore extending therethrough, the method comprising:
injecting an organic waste bearing fluid into the subterranean formation through the wellbore, the organic waste bearing fluid including a methane producing bacteria;
producing methane in the subterranean formation using the methane producing bacteria;
injecting a biocide bearing fluid into the subterranean formation through the wellbore; and
eliminating a portion of the methane producing bacteria in the subterranean formation.

2. The method of claim 1, wherein the biocide bearing fluid is a hypersaline water.

3. The method of claim 1, wherein the biocide bearing fluid includes at least one of the following biocides: chlorine, chlorine dioxide, hydrogen peroxide, bromine, ozone, and ammonium compounds.

4. The method of claim 2, wherein the hypersaline water is waste brine produced at a biowaste treatment plant by reverse osmosis processes.

5. (canceled)

6. The method of claim 1, wherein injecting the organic waste bearing fluid and injecting the biocide bearing fluid is performed in a single batch injection.

7. A method of reducing methane or methane production in a subterranean formation having a wellbore extending therethrough, the method comprising:
injecting an anaerobic methanotrophic bacteria bearing fluid into the subterranean formation through the wellbore; and
eliminating a portion of the methane present in the subterranean formation using the methanotrophic bacteria.

8. The method of claim 7, further comprising injecting an organic waste bearing fluid into the subterranean formation through the wellbore, the organic waste bearing fluid including a methane producing bacteria; and
producing methane in the subterranean formation using the methane producing bacteria

9. The method of claim 8, further comprising injecting methane into the subterranean formation as food for the methanotrophic bacteria.

10. The method of claim 8 further comprising injecting a complex carbon chemical and a reduction agent into the subterranean formation, the reduction agent for reducing the complex carbon chemical into a simple carbon chemical consumable by the methanotrophic bacteria.

11. (canceled)

12. The method of claim 7, further comprising injecting the anaerobic methanotrophic bacteria bearing fluid into a formation leaking methane.

13. A method of reducing the methane or methane production in a subterranean formation having a wellbore extending therethrough, the method comprising:
injecting a reactant bearing fluid into the subterranean formation, the subterranean formation having methane therein; and
in the subterranean formation, reacting the reactant with the methane to create a liquid carbon chemical.

14. (canceled)

15. The method of claim 13, further comprising injecting chlorine as the reactant, and reacting the chlorine with the methane to produce liquid carbon tetrachloride and hydrochloric acid.

16. The method of claim 13, further comprising injecting iodine as the reactant, and reacting the iodine with the methane to produce liquid methyl iodide and liquid hydrochloric acid.

17. The method of claim 13, further comprising injecting an iron bearing chemical as the reactant, and reacting the iron bearing chemical with the methane to produce methanol.

18. The method of claim 13, further comprising injecting an aqueous solution as the reactant, and reacting the aqueous solution with the methane to produce hydrogen and methanol.

19. The method of claim 13, further comprising injecting cerium oxide or copper oxide as the reactant, and reacting the cerium oxide with the methane to produce methanol.

20. The method of claim 13, further comprising injecting a catalyst bearing fluid into the subterranean formation.

21. (canceled)

22. The method of claim 13, further comprising injecting a halogen as the reactant, and reacting the halogen with the methane to produce a haloalkane.

23. The method of claim 13, further comprising injecting an organic waste bearing fluid into the subterranean formation through the wellbore, the organic waste bearing fluid including a methane producing bacteria.

24. (canceled)

25. A method of reducing methane or methane production in a subterranean formation having a wellbore extending therethrough, the method comprising:
injecting an oxygen bearing fluid into the subterranean formation;
mixing the oxygen bearing gas with the methane in the subterranean formation; and
combusting the mixture in the subterranean formation.

26. The method of claim 25, further comprising injecting organic waste bearing fluid into the subterranean formation, producing methane from the organic waste in the subterranean formation, prior to injecting the oxygen bearing fluid into the subterranean formation.

27. A method of reducing methane or methane production in a subterranean formation for the sequestration of organic waste, the formation having a wellbore extending therethrough, the method comprising:
removing methane generating bacteria from a pre-injectate organic waste material;
creating an injectate organic waste bearing fluid; and
injecting the organic waste bearing fluid into the subterranean formation.

28. A method of reducing the methane or methane production in a subterranean formation having a wellbore extending therethrough, the method comprising:
injecting a reactant bearing fluid into the subterranean formation, the subterranean formation having methane therein; and
in the subterranean formation, reacting the reactant with the methane to create a gaseous chemical which is less harmful to the environment than methane.

29-30. (canceled)
